(19) United States
(12) Patent Application Publication
(10) Pub. No.: US 2026/0243921 A1
(43) Pub. Date: Aug. 20, 2026

(54) PRECIPITATION FUSION CORRECTION METHOD FOR NUMERICAL WEATHER PREDICTION MODEL CONSIDERING MULTIVARIATE ENVIRONMENTAL INFORMATION

(71) Applicants: Xi’an University of Technology, Xi'an (CN); Powerchina Northwest Engineering Corporation Limited, Xi'an (CN)

(72) Inventors: Zufeng LI, Xi'an (CN); Yanlong LI, Xi'an (CN); Xiaoliang HE, Xi'an (CN); Yuetao LI, Xi'an (CN); Dangfeng YANG, Xi'an (CN); Lei ZHANG, Xi'an (CN); Qingzhi ZHAO, Xi'an (CN); Ye ZHANG, Xi'an (CN); Lifeng WEN, Xi'an (CN); Peng BU, Xi'an (CN); Siyuan CHEN, Xi'an (CN)

(73) Assignees: Xi’an University of Technology, Xi'an (CN); Powerchina Northwest Engineering Corporation Limited, Xi'an (CN)

(21) Appl. No.: 19/300,044

(22) Filed: Aug. 14, 2025

(30) Foreign Application Priority Data
Feb. 18, 2025 (CN) 202510175362.2

(51) Int. Cl. G01W 1/14; G01W 1/10

(52) U.S. Cl. CPC G01W 1/14; G01W 1/10; G01W 2203/00

(57) ABSTRACT

Disclosed is a precipitation fusion correction method for a numerical weather prediction model considering multivariate environmental information in the technical field of meteorological monitoring, including: acquiring output data from a numerical weather prediction model and precipitation observation data from a rainfall station for a target region; interpolating the output data to the rainfall station to obtain precipitation forecast data corresponding to the output data; calculating a precipitation bias at the rainfall station based on the precipitation observation data from the rainfall station and the precipitation forecast data; calculating, based on the precipitation bias at the rainfall station and multivariate environmental variables for precipitation fusion correction, a predicted precipitation bias value at a grid point of the numerical weather prediction model using a multiscale geographically weighted regression model; and obtaining fused precipitation data based on the predicted precipitation bias value and the output data.

### CROSS-REFERENCE TO RELATED APPLICATIONS

The application claims priority to Chinese patent application No. 202510175362.2, filed on Feb. 18, 2025, the entire contents of which are incorporated herein by reference.

### TECHNICAL FIELD

The present invention relates to the technical field of meteorological monitoring, and in particular, to a precipitation fusion correction method for a numerical weather prediction model considering multivariate environmental information.

### BACKGROUND

Precipitation forecasting has long been an important research topic in meteorology and is widely applied in various fields such as meteorological warning, disaster prevention and control, and agricultural irrigation. With the advancement of numerical weather prediction (NWP) technology, numerical weather prediction models (such as global meteorological models and regional meteorological models) have become the primary tools for precipitation forecasting. However, due to the complexity and variability of atmospheric processes, numerical weather prediction still faces many challenges in precipitation forecasting, particularly regarding the accuracy of local and short-term precipitation predictions.

Existing numerical weather prediction models mainly rely on physical parameterization schemes to simulate atmospheric processes, including cloud physics, precipitation formation, radiation, and convection. However, due to the high complexity and unpredictability of these physical processes, the precipitation forecasts output by the existing numerical weather prediction models often exhibit biases in practical applications. For example, under some complex terrain and atmospheric conditions, the existing numerical weather prediction models tend to produce larger precipitation forecast errors, resulting in insufficient spatial accuracy. This is particularly evident in mountainous and coastal regions, where the spatial distribution and variability of precipitation are more complex and frequently influenced by local factors.

In addition to numerical weather prediction models, precipitation observation data from rainfall stations and remote sensing data have been utilized as important auxiliary data sources for improving precipitation forecasting. Conventional precipitation prediction methods, such as experience-based statistical regression models and weighted averaging methods, while capable of reducing numerical weather prediction errors to some extent, often neglect the influence of geographical features and local meteorological variables on precipitation prediction. Consequently, these methods struggle to achieve high-precision precipitation forecasting.

Therefore, how to effectively fuse multi-source data (e.g., numerical weather prediction data, ground observation data, and remote sensing data) while fully considering geographical and meteorological factors remains a critical problem to be solved.

### SUMMARY

To solve the problem in the prior art, the present invention provides a precipitation fusion correction method for a numerical weather prediction model considering multivariate environmental information.

According to a first aspect of the embodiments of the present invention, a precipitation fusion correction method for a numerical weather prediction model considering multivariate environmental information is provided, including the following steps:
acquiring output data from a numerical weather prediction model and precipitation observation data from a rainfall station for a target region;
interpolating the output data to the rainfall station to obtain precipitation forecast data corresponding to the output data;
calculating a precipitation bias at the rainfall station based on the precipitation observation data from the rainfall station and the precipitation forecast data;
calculating, based on the precipitation bias at the rainfall station and multivariate environmental variables for precipitation fusion correction, a predicted precipitation bias value at a grid point of the numerical weather prediction model using a multiscale geographically weighted regression model; and
obtaining fused precipitation data based on the predicted precipitation bias value and the output data.

In some exemplary embodiments of the present invention, based on the foregoing solution, the output data WRF_Prcp of the numerical weather prediction model for the target region is calculated as follows:

$$WRF\_Prcp = RAINC + RAINNC + RAINSH$$

where RAINC represents precipitation generated by cumulus convection processes; RAINNC represents precipitation generated by cloud microphysical processes; and RAINSH represents precipitation generated by shallow convection processes.

In some exemplary embodiments of the present invention, based on the foregoing solution, before the step of calculating the precipitation bias at the rainfall station based on the precipitation observation data from the rainfall station and the precipitation forecast data, the precipitation fusion correction method for the numerical weather prediction model considering the multivariate environmental information further includes:
determining, based on longitude and latitude information of the rainfall station, row and column positions of the rainfall station in a grid of the numerical weather prediction model; and
obtaining the precipitation forecast data corresponding to the target rainfall station based on row and column indices of a grid point in the grid of the numerical weather prediction model.

In some exemplary embodiments of the present invention, based on the foregoing solution, the multivariate environmental variables for the precipitation fusion correction include geographical variables and meteorological variables, where the geographical variables include elevation data from a digital elevation model, slope data, and distance-to-coastline data; and
the meteorological variables include, as global independent variables, wind speed data and surface temperature data from the China Meteorological Administration Land Data Assimilation System.

The step of calculating, based on the precipitation bias at the rainfall station and the multivariate environmental variables for the precipitation fusion correction, the predicted precipitation bias value at the grid point of the numerical weather prediction model using the multiscale geographically weighted regression model includes:
interpolating the multivariate environmental variables for the precipitation fusion correction to the grid point of the numerical weather prediction model and the rainfall station respectively to obtain a first grid-point-interpolated multivariate environmental variable and a second rainfall-station-interpolated multivariate environmental variable;
calculating, based on the precipitation bias at the rainfall station and the second multivariate environmental variable, model coefficients for the multivariate environmental variables at the rainfall station using the multiscale geographically weighted regression model; and
interpolating the model coefficients to the grid point of the numerical weather prediction model, and calculating the predicted precipitation bias value at the grid point of the numerical weather prediction model by combining the first multivariate environmental variable.

In some exemplary embodiments of the present invention, based on the foregoing solution, the step of calculating, based on the precipitation bias at the rainfall station and the second multivariate environmental variable, the model coefficients for the multivariate environmental variables at the rainfall station using the multiscale geographically weighted regression model includes:

$${Y}_{i} = {\sum }_{j = 1}^{k} {β}_{{b}_{w , j}} ( {u}_{i} , {v}_{i} ) {x}_{i , j} + ε$$

where Yᵢ represents a response variable, namely the precipitation bias at the rainfall station; x_{i,j} represents a covariate, namely the second multivariate environmental variable; βb_{w,j} represents a model coefficient for a j^{th} rainfall station with a bandwidth of b_{w}; uᵢ, vᵢ represent a spatial geographical location of the rainfall station; ε represents a model regression residual; and k represents the total number of rainfall stations.

In some exemplary embodiments of the present invention, based on the foregoing solution, the step of interpolating the model coefficients to the grid point of the numerical weather prediction model, and calculating the predicted precipitation bias value f(Pₒ−Pₛ)ᵢ at the grid point of the numerical weather prediction model by combining the first multivariate environmental variable includes:

$${f ( {p}_{o} - {p}_{s} )}_{i} = {\sum }_{k = 1}^{{n}_{1}} {a}_{ik} {x}_{ik} + {\sum }_{r = 1}^{{n}_{2}} {a}_{ir} {x}_{ir} + {ε}_{i}$$

where Pₒ represents an observed precipitation value; Pₛ represents the precipitation forecast data; xᵢₖ represents a k^{th} geographical variable among the first multivariate environmental variables at a location i; aᵢₖ represents a regression coefficient for the k^{th} geographical variable at the location i; n represents the total number of geographical variables; xᵢᵣ represents an r^{th} global meteorological variable among the first multivariate environmental variables at the location i; aᵢᵣ represents a regression coefficient for the r^{th} global meteorological variable at the location i; n₂ represents the total number of meteorological variables; and εᵢ represents a random error of the model.

In some exemplary embodiments of the present invention, based on the foregoing solution, the step of obtaining the fused precipitation data P_{f} based on the predicted precipitation bias value and the output data includes:

$${P}_{f} = {P}_{s} + f ( {P}_{o} - {P}_{s} )$$

where Pₛ represents the output data; and f(Pₒ−Pₛ) represents the predicted precipitation bias value.

According to a second aspect of the embodiments of the present invention, an apparatus based on the precipitation fusion correction method for the numerical weather prediction model considering the multivariate environmental information as described above, including:
a data acquisition module configured to acquire output data from a numerical weather prediction model and precipitation observation data from a rainfall station for a target region;
an interpolation processing module configured to interpolate the output data to the rainfall station to obtain precipitation forecast data corresponding to the output data;
a bias calculation module configured to calculate a precipitation bias at the rainfall station based on the precipitation observation data from the rainfall station and the precipitation forecast data;
a bias prediction module configured to calculate, based on the precipitation bias at the rainfall station and multivariate environmental variables for precipitation fusion correction, a predicted precipitation bias value at a grid point of the numerical weather prediction model using a multiscale geographically weighted regression model; and
a result output module configured to obtain fused precipitation data based on the predicted precipitation bias value and the output data.

According to a third aspect of the embodiments of the present invention, an electronic device is provided, including: a processor; and a memory with a computer-readable instruction stored thereon, where the computer-readable instruction, when executed by the processor, implements the precipitation fusion correction method for the numerical weather prediction model considering the multivariate environmental information as described in the first aspect.

According to a fourth aspect of the embodiments of the present invention, a computer-readable storage medium is provided, having a computer program stored thereon, where the computer program, when executed by a processor, implements the precipitation fusion correction method for the numerical weather prediction model considering the multivariate environmental information as described in the first aspect.

The technical solution provided by the embodiments of the present invention may have the following beneficial effects:
by fusing the output data from the numerical weather prediction model with the precipitation observation data from the rainfall station, the present invention can effectively reduce biases of a standalone numerical prediction model and enhance precipitation forecasting accuracy; and through the introduction of the multiscale geographically weighted regression (MGWR) model, the present invention can eliminate single-bandwidth assumption limitations of conventional regression methods, thereby better reflecting the spatial variability of precipitation. Particularly under complex terrain and climatic conditions, the MGWR model can dynamically adjust regression coefficients based on local geographical features (such as elevation, slope, and distance to coastline) and global meteorological conditions (such as wind speed and surface temperature), thereby enabling precise correction of precipitation biases and significantly improving precipitation prediction accuracy for local regions.

It should be understood that the above general description and the following detailed description are only exemplary and explanatory, and cannot limit the present invention.

### BRIEF DESCRIPTION OF THE DRAWINGS

The accompanying drawings herein are incorporated in the specification as a part of the present invention, showing embodiments that are implemented in accordance with the present invention and used together with the specification to explain the principle of the present invention.

FIG. 1 is a schematic diagram of a system architecture of an exemplary application environment in which a precipitation fusion correction method for a numerical weather prediction model considering multivariate environmental information according to an embodiment of the present invention can be applied;

FIG. 2 is a schematic flow chart of a precipitation fusion correction method for a numerical weather prediction model considering multivariate environmental information according to some embodiments of the present invention;

FIG. 3 is a schematic diagram of an apparatus based on a precipitation fusion correction method for a numerical weather prediction model considering multivariate environmental information according to some embodiments of the present invention;

FIG. 4 is a schematic structural diagram of a computer system of an electronic device according to some embodiments of the present invention; and

FIG. 5 is a schematic diagram of a computer-readable storage medium according to some embodiments of the present invention.

### DETAILED DESCRIPTION OF THE EMBODIMENTS

Exemplary embodiments of the present invention will be described below in detail, with examples illustrated in the accompanying drawings. When the following description refers to the accompanying drawings, unless otherwise indicated, identical reference signs in different accompanying drawings represent identical or similar elements. The implementation manners described in the following exemplary embodiments do not represent all implementation manners consistent with the present invention. Rather, they are merely examples of apparatuses and methods consistent with some aspects of the present invention as detailed in the appended claims.

The terms used herein are for the purpose of describing specific embodiments only and are not intended to limit the present invention. Unless otherwise clearly indicated in the context, the singular forms “a”, “said”, and “the” used in the present invention and the appended claims are also intended to include the plural forms thereof. It should also be understood that the term “and/or” as used herein refers to and includes any or all possible combinations of one or more relevant listed items.

It should be understood that, although the terms “first”, “second”, “third”, etc. may be used herein to describe various information, such information should not be limited by these terms, which are only used to distinguish the same type of information from each other. For example, without departing from the scope of the present invention, “first” information may also be called “second” information, and similarly, “second” information may also be called “first” information. Depending on the context, the term “if” as used herein may be interpreted as “when”, or “in the case that”, or “in response to a determination”.

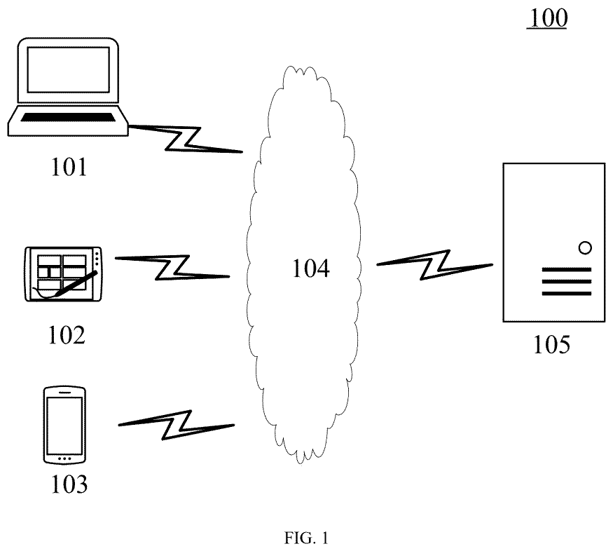

FIG. 1 is a schematic diagram of a system architecture of an exemplary application environment in which a precipitation fusion correction method for a numerical weather prediction model considering multivariate environmental information and an apparatus based on the same according to an embodiment of the present invention can be applied.

As shown in FIG. 1, the system architecture 100 may include one or more of terminal devices such as a desktop computer 101, a laptop computer 102, and a smartphone 103, a network 104, and a server 105, where the network 104 serves as a medium to provide a communication link between the terminal devices and the server 105, and may include various connection types such as wired connections, wireless communication links, or fiber optic cables; and the terminal devices may be various electronic devices with data processing capabilities, each equipped with a display screen for presenting rainfall prediction data to users, including but not limited to the aforementioned desktop computer, laptop computer, and smartphone. It should be understood that the number of terminal devices, networks, and servers shown in FIG. 1 is merely illustrative. Depending on implementation requirements, any number of terminal devices, networks, and servers may be employed. For example, the server 105 may be a sub-server cluster composed of multiple sub-servers.

The precipitation fusion correction method for the numerical weather prediction model considering the multivariate environmental information provided in this embodiment of the present invention may typically be executed by a terminal device, and correspondingly, the apparatus based on the same may typically be arranged in the terminal device. However, it will be readily understood by those skilled in the art that the precipitation fusion correction method for the numerical weather prediction model considering the multivariate environmental information provided in this embodiment of the present invention may also be executed by a server 105, and correspondingly, the apparatus based on the same may also be arranged in the server 105, which is not specifically limited in this exemplary embodiment.

In addition, it should be understood that the precipitation fusion correction method for the numerical weather prediction model considering the multivariate environmental information provided in this embodiment of the present invention may be configured as a software module. In some implementation scenarios, the precipitation fusion correction method for the numerical weather prediction model considering the multivariate environmental information provided by the present invention may be deployed independently to perform rainfall forecasting for different target regions. In other implementation scenarios, the precipitation fusion correction method for the numerical weather prediction model considering the multivariate environmental information provided by the present invention may be deployed in other software as a functional module thereof, for example, in rainfall analysis software. The present invention imposes no specific limitations on the application manner of the precipitation fusion correction method for the numerical weather prediction model considering the multivariate environmental information.

Next, the embodiments of the present invention are described below in detail.

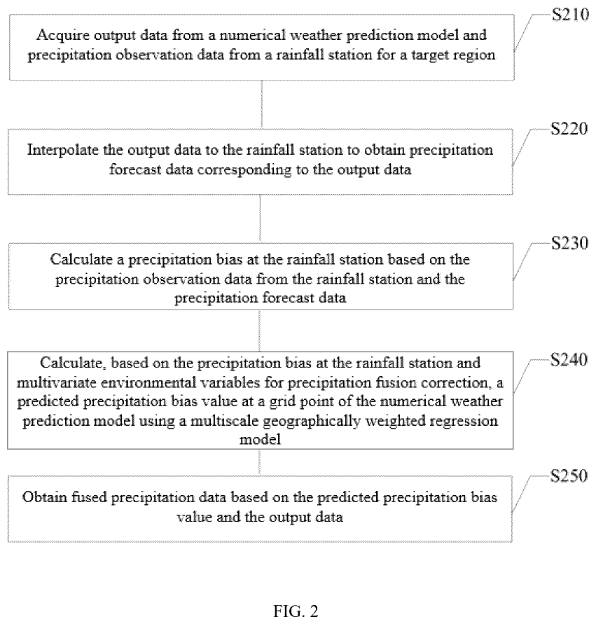

FIG. 2 is a schematic flow chart of a precipitation fusion correction method for a numerical weather prediction model considering multivariate environmental information according to an exemplary embodiment of the present invention. The method includes the following steps:
S210: acquiring output data from a numerical weather prediction model and precipitation observation data from a rainfall station for a target region;
S220: interpolating the output data to the rainfall station to obtain precipitation forecast data corresponding to the output data;
S230: calculating a precipitation bias at the rainfall station based on the precipitation observation data from the rainfall station and the precipitation forecast data;
S240: calculating, based on the precipitation bias at the rainfall station and multivariate environmental variables for precipitation fusion correction, a predicted precipitation bias value at a grid point of the numerical weather prediction model using a multiscale geographically weighted regression model; and
S250: obtaining fused precipitation data based on the predicted precipitation bias value and the output data.

In the step S210, output data from a numerical weather prediction model and precipitation observation data from a rainfall station for a target region are acquired.

The numerical weather prediction model employed in the present invention includes a weather research and forecasting (WRF) model.

The WRF model utilizes fluid dynamics equations and atmospheric physical process parameterization schemes to simulate the evolution of atmospheric states, and can simulate target regions through high-resolution grids and predict variations in various atmospheric physical processes, particularly suitable for short-term weather forecasting and local meteorological process simulation. It has the characteristics of high resolution, parallel computing, and flexible grid configuration.

The present invention employs the fifth generation ECMWF atmospheric reanalysis of the global climate (ERA5) as background field data, with parameters such as grid resolution and physical parameterization schemes set according to specific survey region requirements and climate change characteristics, and multi-source observation data assimilation (i.e., assimilation of data from different observation systems, such as ground meteorological station data, satellite data, and weather radar data) is incorporated to further improve the initial field quality of the WRF model.

The WRF model based on multi-source observation data assimilation performs numerical weather simulations for specific regions and outputs precipitation amounts generated by cumulus convection processes, cloud microphysical processes, and shallow convection processes, and then actual precipitation grid data (i.e., the output data of the numerical weather prediction model for the target region) expressed as WRF_Prcp are obtained through calculation:

$$WRF\_Prcp = RAINC + RAINNC + RAINSH$$

where RAINC represents precipitation generated by cumulus convection processes; RAINNC represents precipitation generated by cloud microphysical processes; and RAINSH represents precipitation generated by shallow convection processes.

The target region refers to a specific geographical region for which precipitation prediction is performed, which may be a country, region, or local area. The output data from the numerical weather prediction model for the target region is acquired to enable precipitation forecasting for the target region through the numerical weather prediction model.

The rainfall stations are physical precipitation observation sites, typically located at specific geographical locations, with a limited number distributed throughout the forecast region.

The numerical weather prediction model can provide large-scale weather forecasts but exhibits insufficient accuracy in certain local areas, whereas ground-based rainfall stations can offer relatively precise local information but have limited spatial resolution. By combining these two types of data, the forecasting accuracy and resolution can be effectively improved, particularly under complex terrain or climatic conditions.

In the step S220, the output data is interpolated to the rainfall station to obtain precipitation forecast data corresponding to the output data.

Here, the output data may be interpolated to the rainfall station using linear interpolation, polynomial interpolation, spline interpolation, Kriging interpolation, or the like.

In the step S230, a precipitation bias at the rainfall station is calculated based on the precipitation observation data from the rainfall station and the precipitation forecast data.

In some implementation manners, before the step of calculating the precipitation bias at the rainfall station based on the precipitation observation data from the rainfall station and the precipitation forecast data corresponding to the rainfall station, the precipitation fusion correction method for the numerical weather prediction model considering the multivariate environmental information further includes:
determining, based on longitude and latitude information of the rainfall station, row and column positions of the rainfall station in a grid of the numerical weather prediction model; and
obtaining the precipitation forecast data corresponding to the target rainfall station based on row and column indices of a grid point in the grid of the numerical weather prediction model.

The WRF model employs a gridded manner for meteorological data simulation, where each grid point corresponds to a specific spatial location, thus requiring the mapping of each rainfall station to row and column positions within the grid through longitude and latitude coordinates. By calculating the relationship between the rainfall station's longitude and latitude coordinates and the grid's longitude and latitude ranges, the rainfall station's row and column indices within the grid are determined:

$$row = \frac{{lats}_{max} - {lat}_{s}}{delta}$$

$$col = \frac{{lon}_{s} - {lon}_{min}}{delta}$$

where row represents the row position of the rainfall station within the WRF grid; col represents the column position of the rainfall station within the WRF grid; delta represents the spatial resolution of precipitation data from the WRF grid; latsₘₐₓ represents the maximum latitude of the WRF grid; lonₘᵢₙ represents the minimum longitude of the WRF grid; lats represents the latitude of the rainfall station; and lonₛ represents the longitude of the rainfall station.

Based on the rainfall station's location (row and column indices), the precipitation forecast data for the corresponding grid point can be extracted from the WRF model's output data.

Once the precipitation forecast data for the corresponding grid point is obtained, the precipitation bias can be obtained by subtracting the precipitation forecast data from the rainfall station's precipitation observation data.

In the step S240, based on the precipitation bias at the rainfall station and multivariate environmental variables for precipitation fusion correction, a predicted precipitation bias value at a grid point of the numerical weather prediction model is calculated using a multiscale geographically weighted regression model.

Here, the multivariate environmental variables for the precipitation fusion correction include geographical variables and meteorological variables, where the geographical variables include elevation data from a digital elevation model, slope data, and distance-to-coastline data; and
the meteorological variables include, as global independent variables, wind speed data and surface temperature data from the China Meteorological Administration Land Data Assimilation System.

Elevation represents the altitude of each location within the target region and significantly influences precipitation distribution and intensity, as higher terrain typically promotes air uplift and precipitation formation; slope represents the degree of surface inclination, generally associated with topographic relief, where steeper slopes may affect airflow movement and precipitation generation; and distance to coastline describes each location's distance to the nearest coastline, with coastal regions typically exhibiting different climate and precipitation patterns compared to inland regions, as locations nearer to coastlines may experience marine climate influences and greater precipitation amounts. Since the elevation, slope, and distance-to-coastline data generally exhibit local effects that are closely correlated with terrain and geographical features, with their influence typically confined to specific geographical regions, they are treated as local independent variables.

Wind speed is a critical factor in meteorological systems that can influence weather and precipitation patterns over extensive areas, where variations in wind speed are not only affected by local geographical conditions but also controlled by large-scale climate systems and atmospheric circulation, exhibiting high spatial expansibility, such that its impact on precipitation manifests at regional or even global scales; for example, variations in wind speed within the atmospheric circulation can modulate precipitation distribution across a region. Similarly, the surface temperature exerts global-scale influence on precipitation by directly affecting evaporation, humidity levels, and atmospheric water vapor content, thereby influencing precipitation formation processes, and it is subject to extensive influences from atmospheric circulation, seasonal variations, and other factors with effects potentially covering multiple geographical regions. Therefore, both the wind speed and the surface temperature are treated as global independent variables.

The multiscale geographically weighted regression (MGWR) model, as a type of geographically weighted regression model, can flexibly adjust regression coefficients according to different spatial locations, and unlike conventional regression approaches, the MGWR model considers both local-scale effects (e.g., effects of local climatic features and geographical factors on precipitation) and global-scale effects (e.g., effects of regional meteorological conditions), thereby ensuring correct capture of precipitation variability across multiple scales. Moreover, the MGWR model adaptively adjusts regression coefficients according to different spatial locations, assigning differential weights to different regional data in the regression analysis to improve local precipitation bias correction. Specifically, by processing spatial variability in precipitation forecast data according to local geographical and meteorological factors, the MGWR model can generate more precise correction results.

By incorporating multiscale geographical and meteorological factors, the MGWR model enables precise correction of spatial variability in precipitation forecast data, particularly for regions characterized by complex terrain and great local climate variations, thereby effectively improving precipitation prediction accuracy and reliability.

Based on the foregoing, the step of calculating, based on the precipitation bias at the rainfall station and the multivariate environmental variables for the precipitation fusion correction, the predicted precipitation bias value at the grid point of the numerical weather prediction model using the multiscale geographically weighted regression model includes:
interpolating the multivariate environmental variables for the precipitation fusion correction to the grid point of the numerical weather prediction model and the rainfall station respectively to obtain a first grid-point-interpolated multivariate environmental variable and a second rainfall-station-interpolated multivariate environmental variable;
calculating, based on the precipitation bias at the rainfall station and the second multivariate environmental variable, model coefficients for the multivariate environmental variables at the rainfall station using the multiscale geographically weighted regression model; and
interpolating the model coefficients to the grid point of the numerical weather prediction model, and calculating the predicted precipitation bias value at the grid point of the numerical weather prediction model by combining the first multivariate environmental variable.

The present invention employs a bilinear interpolation method to interpolate the multivariate environmental variables for the precipitation fusion correction to the grid point of the numerical weather prediction model and the rainfall station respectively. The bilinear interpolation method calculates a weighted average of four adjacent data points to derive the interpolated result for the target point, thereby ensuring data of different resolutions can be properly aligned on the same grid for subsequent analysis.

The rainfall stations refer to physical ground-based precipitation observation sites, where interpolation is employed to map geographical factors (such as elevation, slope, and distance to coastline) and meteorological observation data (such as wind speed and temperature) onto these stations, thereby obtaining independent variable values consistent with the observation data.

Finally, precipitation fusion correction is performed using the first grid-point-interpolated multivariate environmental variable and the second rainfall-station-interpolated multivariate environmental variable, and the MGWR model conducts regression analysis based on the input meteorological and geographical independent variables to predict the precipitation bias of the numerical weather prediction model for the target region and further derive fused precipitation data. The fused precipitation data will provide important information support for weather warnings, agricultural production, irrigation, and disaster management.

The step of calculating, based on the precipitation bias at the rainfall station and the second multivariate environmental variable, model coefficients for the multivariate environmental variables at the rainfall station using the multiscale geographically weighted regression model includes:

$${Y}_{i} = {\sum }_{j = 1}^{k} {β}_{{b}_{w , j}} ( {u}_{i} , {v}_{i} ) {x}_{i , j} + ε$$

where Yᵢ represents a response variable, namely the precipitation bias at the rainfall station; x_{i,j} represents a covariate, namely the second multivariate environmental variable; βb_{w,j} represents a model coefficient for a j^{th} rainfall station with a bandwidth of b_{w}; uᵢ, vᵢ represent a spatial geographical location of the rainfall station; & represents a model regression residual; and k represents the total number of rainfall stations.

That is to say, by substituting the precipitation bias data and the geographical variables (such as elevation, slope, and distance to coastline) and meteorological variables (such as wind speed and surface temperature) into the aforementioned equation, the regression coefficients for the rainfall station can be calculated. The regression coefficients represent the degree of influence exerted by the geographical and meteorological variables on precipitation bias correction at a specific rainfall site. Through the MGWR model, precise regression coefficients can be obtained at local spatial scales, thereby enabling each rainfall station to possess distinct correction factors.

Upon obtaining the regression coefficients for each rainfall station, these regression coefficients are required to be transformed onto the grid points of the WRF model through interpolation, thereby generating corresponding model coefficients for each grid point. The interpolation process ensures continuous spatial distribution of the regression coefficients across the entire grid domain.

Based on the regression coefficients, geographical variables, and meteorological variables corresponding to each grid point, the precipitation bias for each grid point can be calculated. The precipitation bias represents the difference between the WRF model's predicted precipitation and the actual observation data, serving as a means for evaluating model prediction accuracy. To mitigate the impact of different dimensional data, the precipitation bias may undergo normalization processing to achieve a mean of 0 and variance of 1, thereby enhancing calculation stability and accuracy.

The step of interpolating the model coefficients to the grid point of the numerical weather prediction model, and calculating the predicted precipitation bias value at the grid point of the numerical weather prediction model by combining the first multivariate environmental variable includes:

$${f ( {p}_{o} - {p}_{s} )}_{i} = {\sum }_{k = 1}^{{n}_{1}} {a}_{ik} {x}_{ik} + {\sum }_{r = 1}^{{n}_{2}} {a}_{ir} {x}_{ir} + {ε}_{i}$$

where Pₒ represents an observed precipitation value; Pₛ represents the precipitation forecast data; xᵢₖ represents a k^{th} geographical variable among the first multivariate environmental variables at a location i; aᵢₖ represents a regression coefficient for the k^{th} geographical variable at the location i; n₁ represents the total number of geographical variables; xᵢᵣ represents an r^{th} global meteorological variable among the first multivariate environmental variables at the location i; aᵢᵣ represents a regression coefficient for the r^{th} global meteorological variable at the location i; n₂ represents the total number of meteorological variables; and εᵢ represents a random error of the model. The observed precipitation value represented by Pₒ refers to the observed precipitation value corresponding to the precipitation grid of the numerical weather prediction model.

The normalized precipitation bias may be utilized for further analysis and model correction. During the denormalization process, the true value of normalized precipitation bias is first obtained through interpolation calculations, followed by calculation of its mean and variance. Then, the mean and variance are employed to denormalize the bias within the precipitation grid of the numerical weather prediction model, thereby obtaining the actual grid-based predicted precipitation bias value.

In the step S250, fused precipitation data is obtained based on the predicted precipitation bias value and the output data.

The present invention imposes no specific limitations on the implementation manner for this step. For example, in some implementation manners, fused precipitation data is obtained based on the predicted precipitation bias value and the precipitation forecast data using weighted averaging methods, differential methods, least squares regression methods, or other methods.

In an implementation manner of the present invention, the step of obtaining the fused precipitation data P_{f} based on the predicted precipitation bias value and the output data includes:

$${P}_{f} = {P}_{s} + f ( {P}_{o} - {P}_{s} )$$

where Pₛ represents the output data; and f(Pₒ−Pₛ) represents the predicted precipitation bias value.

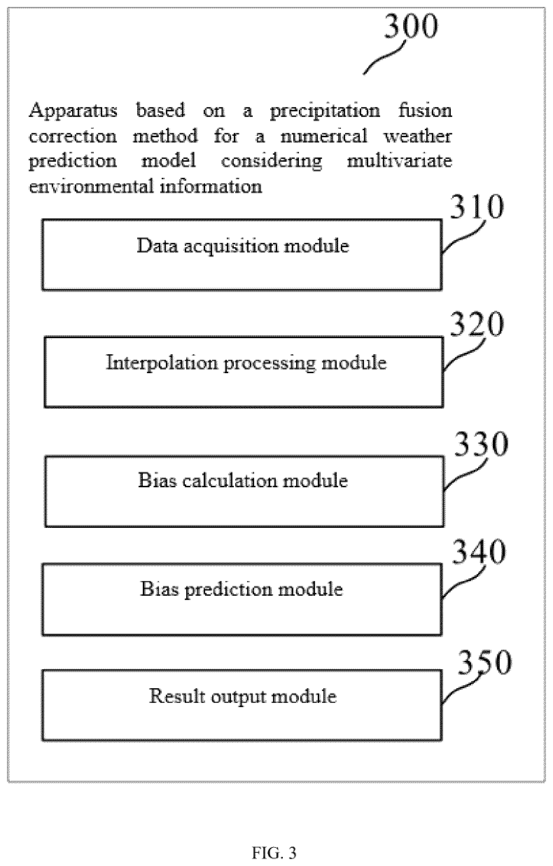

According to a second aspect of the embodiments of the present invention, an apparatus based on a precipitation fusion correction method for a numerical weather prediction model considering multivariate environmental information is further provided. Referring to FIG. 3, the apparatus based on the precipitation fusion correction method for the numerical weather prediction model considering the multivariate environmental information includes:
a data acquisition module 310 configured to acquire output data from a numerical weather prediction model and precipitation observation data from a rainfall station for a target region;
an interpolation processing module 320 configured to interpolate the output data to the rainfall station to obtain precipitation forecast data corresponding to the output data;
a bias calculation module 330 configured to calculate a precipitation bias at the rainfall station based on the precipitation observation data from the rainfall station and the precipitation forecast data;
a bias prediction module 340 configured to calculate, based on the precipitation bias at the rainfall station and multivariate environmental variables for precipitation fusion correction, a predicted precipitation bias value at a grid point of the numerical weather prediction model using a multiscale geographically weighted regression model; and
a result output module 350 configured to obtain fused precipitation data based on the predicted precipitation bias value and the output data.

It should be noted that although the foregoing detailed description mentions multiple modules of the apparatus based on the precipitation fusion correction method for the numerical weather prediction model considering the multivariate environmental information, such division is not mandatory. In practice, according to the implementation manners of the present invention, the features and functions of two or more modules described above may be embodied in a single module or unit. Conversely, the features and functions of one module described above may be further subdivided and embodied across multiple modules or submodules.

Moreover, in an exemplary embodiment of the present invention, an electronic device capable of implementing the precipitation fusion correction method for the numerical weather prediction model considering the multivariate environmental information as described above is further provided.

Those skilled in the art will appreciate that various aspects of the present invention may be implemented as systems, methods, or program products. Accordingly, various aspects of the present invention may be embodied in the following forms: complete hardware embodiments, complete software embodiments (including firmware, microcode, etc.), or embodiments combining both hardware and software aspects, which may collectively be referred to herein as “circuits”, “modules”, or “systems”.

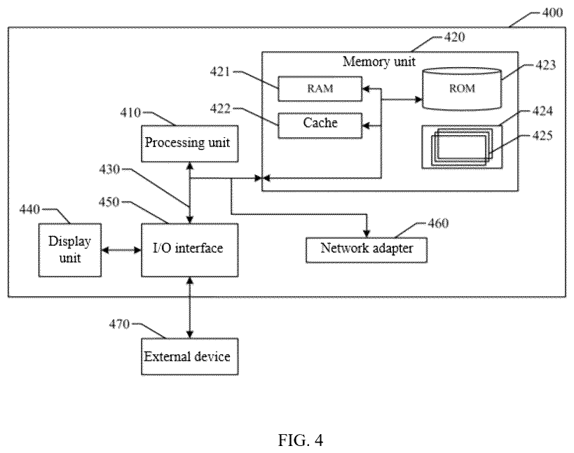

An electronic device 400 according to such an embodiment of the present invention is described below with reference to FIG. 4. The electronic device 400 shown in FIG. 4 is merely an example and should not limit the functions and scope of use of the embodiment of the present invention.

As shown in FIG. 4, the electronic device 400 is embodied in the form of a general-purpose computing device, where the components of the electronic device 400 may include, but are not limited to: at least one processing unit 410 as described above, at least one memory unit 420 as described above, a bus 430 connecting different system components (including the memory unit 420 and the processing unit 410), and a display unit 440.

The memory unit stores program code executable by the processing unit 410, thereby causing the processing unit 410 to perform the steps according to various exemplary embodiments of the present invention as described in the method above. For example, the processing unit 410 may execute the steps of S210: acquiring output data from a numerical weather prediction model and precipitation observation data from a rainfall station for a target region; S220: interpolating the output data to the rainfall station to obtain precipitation forecast data corresponding to the output data; S230: calculating a precipitation bias at the rainfall station based on the precipitation observation data from the rainfall station and the precipitation forecast data; S240: calculating, based on the precipitation bias at the rainfall station and multivariate environmental variables for precipitation fusion correction, a predicted precipitation bias value at a grid point of the numerical weather prediction model using a multiscale geographically weighted regression model; and S250: obtaining fused precipitation data based on the predicted precipitation bias value and the output data as shown in FIG. 2.

The memory unit 420 may include a readable medium in the form of a volatile memory unit, such as a random access memory unit (RAM) 421 and/or a cache memory unit 422, and may further include a read-only memory unit (ROM) 423.

The memory unit 420 may also include a program/utility 424 having a set of (at least one) program modules 425, and such program modules 425 include, but are not limited to: an operating system, one or more application programs, other program modules, and program data, each of which or some combination thereof may include an implementation of a network environment.

The bus 430 may represent one or more of several types of bus architectures, including a memory unit bus or controller, a peripheral bus, an accelerated graphics port, a processing unit, or a local bus using any of a variety of bus architectures.

The electronic device 400 may further communicate with one or more external devices 470 (e.g., keyboards, pointing devices, Bluetooth devices, etc.), one or more devices that enable user interaction with the electronic device 400, and/or any devices (e.g., routers, modems, etc.) that enable communication between the electronic device 400 and one or more other computing devices. Such communication may be implemented through an input/output (I/O) interface 450. Moreover, the electronic device 400 may further communicate with one or more networks (e.g., a local area network (LAN), wide area network (WAN), and/or public network such as the Internet) via a network adapter 460. As shown in the figure, the network adapter 460 communicates with other modules of the electronic device 400 through the bus 430. It should be understood that, although not shown in the figure, other hardware and/or software modules may be utilized in conjunction with the electronic device 400, including but not limited to: microcode, device drivers, redundant processing units, external disk drive arrays, RAID systems, tape drives, and data backup storage systems.

Through the description of the above embodiments, a person skilled in the art may readily understand that the exemplary embodiments described herein may be implemented by software, and may also be implemented by a combination of software with necessary hardware. Therefore, the technical solution according to the embodiments of the present invention may be embodied in the form of a software product. The software product may be stored in a non-volatile storage medium (which may be a CD-ROM, USB flash drive, portable hard disk, or the like) or on a network, and includes several instructions for causing a computing device (which may be a personal computer, server, terminal device, or the like) to perform the method according to the embodiments of the present invention.

In an exemplary embodiment of the present invention, a computer-readable storage medium having stored thereon a program product capable of implementing the aforementioned method of the present invention is further provided. In some possible embodiments, various aspects of the present invention may also be implemented in the form of a program product including program code that, when the program product is executed on a terminal device, causes the terminal device to perform the steps according to various exemplary embodiments of the present invention as described in the method above.

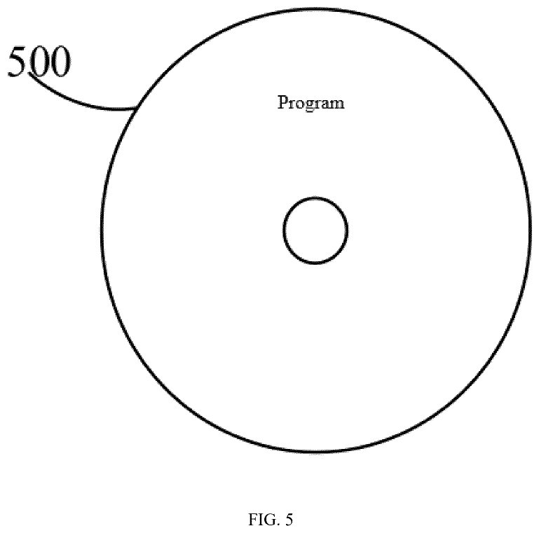

Referring to FIG. 5, it illustrates a program product 500 for implementing the precipitation fusion correction method for the numerical weather prediction model considering the multivariate environmental information as described above according to the embodiments of the present invention, which may employ a portable compact disc read-only memory (CD-ROM) and includes program code executable on a terminal device such as a personal computer; however, the program product of the present invention is not limited thereto, as in the present invention, the readable storage medium may be any tangible medium that contains or stores a program for use by or in combination with an instruction execution system, apparatus, or device.

The program product may employ any combination of one or more readable storage media, where the readable storage medium may be, but is not limited to, an electrical, magnetic, optical, electromagnetic, infrared, or semiconductor system, apparatus, or device, or any combination thereof. More specific examples (a non-exhaustive list) of the readable storage medium include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The program code for performing operations of the present invention may be written in any combination of one or more programming languages, including object-oriented programming languages such as Java and C++, as well as conventional procedural programming languages such as the “C” language or similar programming languages. The program code may be executed entirely on a user's computing device, partly on a user's device, as a stand-alone software package, partly on a user's computing device and partly on a remote computing device, or entirely on a remote computing device or server. In scenarios involving a remote computing device, the remote computing device may be connected to a user's computing device through any type of network, including a local area network (LAN) or wide area network (WAN), or may be connected to an external computing device (e.g., through an Internet service provider via the Internet).

Furthermore, the aforementioned accompanying drawings are merely schematic illustrations of the processes included in the method according to the exemplary embodiments of the present invention and are not for limiting purposes. It will be readily understood that the processes shown in the aforementioned accompanying drawings neither indicate nor restrict the temporal sequence of these processes, and it will also be readily understood that these processes may be performed synchronously or asynchronously, for example, across multiple modules.

Through the description of the above embodiments, a person skilled in the art may readily understand that the exemplary embodiments described herein may be implemented by software, and may also be implemented by a combination of software with necessary hardware. Therefore, the technical solution according to the embodiments of the present invention may be embodied in the form of a software product. The software product may be stored in a non-volatile storage medium (which may be a CD-ROM, USB flash drive, portable hard disk, or the like) or on a network, and includes several instructions for causing a computing device (which may be a personal computer, server, touch control terminal, or the like) to perform the method according to the embodiments of the present invention.

After considering the specification and practicing the present invention disclosed herein, those skilled in the art will easily come up with other embodiments of the present invention. The present invention is intended to cover any variations, uses, or adaptations of the present invention that follow the general principles of the present invention and include common knowledge or customary technical means in the art that are not disclosed in the present invention. The specification and embodiments are to be considered exemplary only, with the true scope and spirit of the present invention being indicated by the appended claims.

It should be understood that the present invention is not limited to the precise structure described above and shown in the accompanying drawings, and various modifications and changes can be made without departing from its scope. The scope of the present invention is limited by the appended claims.

What is claimed is:

1. A precipitation fusion correction method for a numerical weather prediction model considering multivariate environmental information, comprising:
acquiring output data from a numerical weather prediction model and precipitation observation data from a rainfall station for a target region, wherein the the output data WRF_Prcp of the numerical weather prediction model for the target region is calculated as follows:
$$WRF\_Prcp = RAINC + RAINNC + RAINSH$$
wherein RAINC represents precipitation generated by cumulus convection processes; RAINNC represents precipitation generated by cloud microphysical processes; and RAINSH represents precipitation generated by shallow convection processes;
interpolating the output data to the rainfall station to obtain precipitation forecast data corresponding to the output data;
calculating a precipitation bias at the rainfall station based on the precipitation observation data from the rainfall station and the precipitation forecast data;
calculating, based on the precipitation bias at the rainfall station and multivariate environmental variables for precipitation fusion correction, a predicted precipitation bias value at a grid point of the numerical weather prediction model using a multiscale geographically weighted regression model, wherein the multivariate environmental variables for the precipitation fusion correction comprise geographical variables and meteorological variables, wherein the geographical variables comprise elevation data from a digital elevation model, slope data, and distance-to-coastline data; and the meteorological variables comprise, as global independent variables, wind speed data and surface temperature data from the China Meteorological Administration Land Data Assimilation System; and
obtaining fused precipitation data based on the predicted precipitation bias value and the output data.

2. The precipitation fusion correction method for the numerical weather prediction model considering the multivariate environmental information of claim 1, wherein before the step of calculating the precipitation bias at the rainfall station based on the precipitation observation data from the rainfall station and the precipitation forecast data, the precipitation fusion correction method for the numerical weather prediction model considering the multivariate environmental information further comprises:
determining, based on longitude and latitude information of the rainfall station, row and column positions of the rainfall station in a grid of the numerical weather prediction model; and
obtaining the precipitation forecast data corresponding to the target rainfall station based on row and column indices of a grid point in the grid of the numerical weather prediction model.

3. The precipitation fusion correction method for the numerical weather prediction model considering the multivariate environmental information of claim 1, wherein the step of calculating, based on the precipitation bias at the rainfall station and the multivariate environmental variables for the precipitation fusion correction, the predicted precipitation bias value at the grid point of the numerical weather prediction model using the multiscale geographically weighted regression model comprises:
interpolating the multivariate environmental variables for the precipitation fusion correction to the grid point of the numerical weather prediction model and the rainfall station respectively to obtain a first grid-point-interpolated multivariate environmental variable and a second rainfall-station-interpolated multivariate environmental variable;
calculating, based on the precipitation bias at the rainfall station and the second multivariate environmental variable, model coefficients for the multivariate environmental variables at the rainfall station using the multiscale geographically weighted regression model; and
interpolating the model coefficients to the grid point of the numerical weather prediction model, and calculating the predicted precipitation bias value at the grid point of the numerical weather prediction model by combining the first multivariate environmental variable.

4. The precipitation fusion correction method for the numerical weather prediction model considering the multivariate environmental information of claim 3, wherein the step of calculating, based on the precipitation bias at the rainfall station and the second multivariate environmental variable, model coefficients for the multivariate environmental variables at the rainfall station using the multiscale geographically weighted regression model comprises:
$${Y}_{i} = {\sum }_{j = 1}^{k} {β}_{{b}_{w , j}} ( {u}_{i} , {v}_{i} ) {x}_{i , j} + ε$$
wherein Yᵢ represents a response variable, namely the precipitation bias at the rainfall station; x_{i,j} represents a covariate, namely the second multivariate environmental variable; βb_{w,j} represents a model coefficient for a j^{th} rainfall station with a bandwidth of b_{w}; uᵢ, vᵢ represent a spatial geographical location of the rainfall station; ε represents a model regression residual; and k represents the total number of rainfall stations.

5. The precipitation fusion correction method for the numerical weather prediction model considering the multivariate environmental information of claim 3, wherein the step of interpolating the model coefficients to the grid point of the numerical weather prediction model, and calculating the predicted precipitation bias value f(Pₒ−Pₛ)ᵢ at the grid point of the numerical weather prediction model by combining the first multivariate environmental variable comprises:
$${f ( {p}_{o} - {p}_{s} )}_{i} = {\sum }_{k = 1}^{{n}_{1}} {a}_{ik} {x}_{ik} + {\sum }_{r = 1}^{{n}_{2}} {a}_{ir} {x}_{ir} + {ε}_{i}$$
wherein Pₒ represents an observed precipitation value; Pₛ represents the precipitation forecast data; xᵢₖ represents a k^{th} geographical variable among the first multivariate environmental variables at a location i; aᵢₖ represents a regression coefficient for the k^{th} geographical variable at the location i; n₁ represents the total number of geographical variables; xᵢᵣ represents an r^{th} global meteorological variable among the first multivariate environmental variables at the location i; aᵢᵣ represents a regression coefficient for the r^{th} global meteorological variable at the location i; n₂ represents the total number of meteorological variables; and εᵢ represents a random error of the model.

6. The precipitation fusion correction method for the numerical weather prediction model considering the multivariate environmental information of claim 1, wherein the step of obtaining the fused precipitation data P_{f} based on the predicted precipitation bias value and the output data comprises:
$${P}_{f} = {P}_{s} + f ( {P}_{o} - {P}_{s} )$$
wherein Pₛ represents the output data; and f(Pₒ−Pₛ) represents the predicted precipitation bias value.

7. An apparatus based on the precipitation fusion correction method for the numerical weather prediction model considering the multivariate environmental information of claim 1, comprising:
a data acquisition module configured to acquire output data from a numerical weather prediction model and precipitation observation data from a rainfall station for a target region;
an interpolation processing module configured to interpolate the output data to the rainfall station to obtain precipitation forecast data corresponding to the output data;
a bias calculation module configured to calculate a precipitation bias at the rainfall station based on the precipitation observation data from the rainfall station and the precipitation forecast data;
a bias prediction module configured to calculate, based on the precipitation bias at the rainfall station and multivariate environmental variables for precipitation fusion correction, a predicted precipitation bias value at a grid point of the numerical weather prediction model using a multiscale geographically weighted regression model; and
a result output module configured to obtain fused precipitation data based on the predicted precipitation bias value and the output data.

8. An electronic device, comprising:
a processor; and
a memory with a computer-readable instruction stored thereon, wherein the computer-readable instruction, when executed by the processor, implements the precipitation fusion correction method for the numerical weather prediction model considering the multivariate environmental information of claim 1.
